(19) United States
(12) Patent Application Publication
(10) Pub. No.: US 2012/0291122 A1
(43) Pub. Date: Nov. 15, 2012

(54) Multi Dimensional CAPTCHA System and Method

(75) Inventors: Yang-Wai Chow, Fairy Meadow (AU); Willy Susilo, Keiraville (AU)

(73) Assignee: UNIVERSITY OF WOLLONGONG, Wollongong (AU)

(21) Appl. No.: 13/107,563

(22) Filed: May 13, 2011

(51) Int. Cl. G06T 15/00; G06F 21/00; H04L 9/32

(52) U.S. Cl. 726/19; 345/419

(57) ABSTRACT

A method of providing a Completely Automated Public Turing test to tell Computers and Humans Apart (CAPTCHA), the method comprising the steps of: forming a stereoscopic image including a first and second series of intermingled similar objects, with the first series of objects having a readily distinguishable stereoscopic depth from the second series of objects.

### FIELD OF THE INVENTION

The invention generally relates to the field of “Completely Automated Public Turing test to tell Computers and Humans Apart” (CAPTCHAs) and, in particular, the preferred embodiments disclose a stereographic form of capture.

### BACKGROUND OF THE INVENTION

Any discussion of the prior art throughout the specification should in no way be considered as an admission that such prior art is widely known or forms part of common general knowledge in the field.

In recent years, CAPTCHAs have become ubiquitous on the Internet as a security countermeasure against adverse attacks like distributed denial of service attacks and botnets. While the idea of ‘Automated Turing Tests’ has been around for some time, the term ‘CAPTCHA’ was introduced by von Ahn et al. (von Ahn, L., Blum, M., Hopper, N.J., and Langford, J. (2003) CAPTCHA: Using Hard AI Problems for Security. In Biham) as automated tests that humans can pass, but current computer programs cannot pass. In their seminal work, they describe CAPTCHAs as hard Artificial Intelligence (AI) problems that can be exploited for security purposes.

CAPTCHAs are essentially used as challenge-response tests to distinguish between computers and human users, and have been effective in deterring automated abuse of online services intended for humans. Over the years, many different CAPTCHA schemes have been proposed and deployed on numerous web services, including services provided by major companies such as Google, Yahoo! And Microsoft, and social networks like Facebook. However, a large number of them have been found to be insecure against certain attacks, some of which involve the use of machine learning, computer vision and pattern recognition algorithms (Yan, J. and Ahmad, A. S. E. (2009) CAPTCHA Security: A Case Study. IEEE Security & Privacy, 7, 22-28.).

This has given rise to an arms race between CAPTCHA developers, who attempt to create more secure CAPTCHAs, and attackers, who try to break them. Yan and Ahmad above observe that CAPTCHA development (like cryptography, digital watermarking, and others) is an evolutionary process, as successful attacks in turn lead to the development of more robust systems. Furthermore, they have also suggested that the current collective understanding of CAPTCHAs is rather limited, thus hampering the development of good CAPTCHAs.

The development of a good CAPTCHA scheme is not an easy task as it must be secure against automated attacks, and at the same time, it must be usable by humans (i.e. human-friendly). Of the different categories of CAPTCHAs (e.g. image-based CAPTCHAs, audio CAPTCHAs, etc.) that have emerged thus far, text-based CAPTCHAs are the most common and widely deployed category to date. The popularity of text-based CAPTCHAs is due, in part, to its intuitiveness to users world-wide in addition to its potential to provide strong security.

Text-based CAPTCHAs typically consist of a segmentation challenge, the identification of character locations in the right order, followed by recognition challenges, recognising individual characters. It has been established that computers can outperform humans when it comes to character recognition tasks. As such, if a computer program can reduce a CAPTCHA challenge to the problem of recognising individual characters, it is effectively broken. Therefore, it is widely accepted that text-based CAPTCHAs should be designed to be segmentation-resistant. The current state-of-the-art in robust text-based CAPTCHA design relies on the difference in ability between humans and computers when it comes to the task of segmentation. While there are several proposed methods of designing segmentation-resistant CAPTCHAs, for example, adding clutter and ‘crowding characters together’, most suffer from a tradeoff between the usability of the resulting CAPTCHA and its robustness against novel attacks.

### CAPTCHA Security

CAPTCHA security has been the topic of much scrutiny. A number of researchers have demonstrated that many existing CAPTCHA schemes are vulnerable to automated attacks. Much of this vulnerability stems from certain design flaws in these CAPTCHAs, several of which are described here.

The popular Gimpy family of CAPTCHAs developed at Carnegie Mellon University has been subject to a number of automated attacks. Mori and Malik (Mori, G. and Malik, J. (2003) Recognizing Objects in Adversarial Clutter: Breaking a Visual CAPTCHA. CVPR (1), pp. 134-144) were able to successfully break the EZ-Gimpy CAPTCHA 92% of the time, as well as the Gimpy CAPTCHA at a success rate of 33%. Their work was based on matching shape contexts of characters, in the midst of a background texture, using an image database of known objects. Using the knowledge that the text in this CAPTCHA scheme was based on a set of English words, they then proceeded by ranking a set of candidate words and selecting the one with the best matching score. They also demonstrated a holistic approach of recognising entire words at once, instead of attempting to identify individual characters. This was because in severe clutter, attempting to identify characters itself was often not enough as parts of characters could be occluded or ambiguous. Among other things, this work highlights that CAPTCHAs based on language models are susceptible to dictionary attacks. In fact, with full knowledge of font and lexicon, the Mori-Malik attack also produced reasonably high success rates in solving two other CAPTCHAs schemes; namely, PessimalPrint and BaffleText. Both of these pioneering CAPTCHAs were designed in the research community, and represent research effort exploring the question of how to design text-based CAPTCHAs properly.

Chellapilla and Simard (Chellapilla, K. and Simard, P. Y. (2004) Using Machine Learning to Break Visual Human Interaction Proofs (HIPs). NIPS) demonstrated that machine learning algorithms could be used to break a variety of CAPTCHAs (or Human Interaction Proofs (HIPs)). In their work, they deliberately avoided exploiting language models to break these CAPTCHAs. The aim was to develop a generic method that could automate the task of segmentation (i.e. finding the characters), thus reducing the challenge to a pure recognition problem which is a trivial task using machine learning. This work, by the research team in Microsoft, has led to the segmentation-resistant principle that is now widely accepted as a requirement in the design of more secure text-based CAPTCHAs.

Following on from their work, the team developed a well thought out CAPTCHA scheme that was deployed on a number of Microsoft's online services. While this CAPTCHA was meant to be segmentation-resistant, it was unfortunately shown to be susceptible to a low-cost attack. Among the lessons to be learnt from this work, is that it becomes easier to segment a CAPTCHA in which the total number of characters is known, or can be ascertained, a priori. Nonetheless, despite breaking the CAPTCHA, Yan and Ahmad pointed out that their attack did not overturn or negate the segmentation-resistant principle. Instead, upon closer examination certain CAPTCHAs that are designed to be segmentation-resistant, can actually be segmented after some pre-processing (Ahmad, A. S. E., Yan, J., and Marshall, L. (2010) The Robustness of a New CAPTCHA. In Costa, M. and Kirda, E. (eds.), EUROSEC, pp. 36-41. ACM).

Yan and Ahmad (Yan, J. and Ahmad, A. S. E. (2007) Breaking Visual CAPTCHAs with Naive Pattern Recognition Algorithms. ACSAC, pp. 279-291. IEEE Computer Society) also showed that a number of other CAPTCHAs could be defeated using novel attacks like pixel-count attacks, where characters could be distinguished by simply counting the number of pixels that constituted each individual character. Their work emphasised that in addition to segmentation-resistance, it is good practice to use local and global warping to distort characters in CAPTCHAs. Evidently, local and global distortions alone are not sufficient to deter effective attacks. Moy et al. (Moy, G., Jones, N., Harkless, C., and Potter, R. (2004) Distortion Estimation Techniques in Solving Visual CAPTCHAs. CVPR (2), pp. 23-28) demonstrated breaking EZ-Gimpy and Gimpy-r using distortion estimation techniques. The first step in their approach involved background removal, to separate the text from the background clutter without losing important information. This is also a step that many other attacks employ. Thus, the importance of making it hard to separate the text from the background is also highlighted as a factor that has to be considered when designing secure CAPTCHAs.

While the forgoing discusses text based CAPTCHAs, other categories of CAPTCHAs are by no means immune to automated attacks. For example, an overview of attacks against a number of image-based CAPTCHAs can be found in Zhu et al. (Zhu, B. B., Yan, J., Li, Q., Yang, C., Liu, J., Xu, N., Yi, M., and Cai, K. (2010) Attacks and Design of Image Recognition CAPTCHAs. In Al-Shaer, E., Keromytis, A. D., and Shmatikov, V. (eds.), ACM Conference on Computer and Communications Security, pp. 187-200. ACM.).

### CAPTCHA Usability

In addition to the security strength, or robustness, of a CAPTCHA scheme, the other issue that has to be considered when designing CAPTCHAs is its ease of use for humans. ScatterType is an example of a text-based CAPTCHA that was designed to resist segmentation attacks, however initial usability experiments showed an overall legibility rate of 53%. The legibility rate was subject to the difficulty level of the CAPTCHA challenge. Baird et al.(Baird, H. S., Moll, M. A., and Wang, S.-Y. (2005) A Highly Legible CAPTCHA That Resists Segmentation Attacks. In Baird, H. S. and Lopresti, D. P. (eds.), HIP, Lecture Notes in Computer Science, 3517, pp. 27-41. Springer) stated that the CAPTCHA generation parameter range could be controlled to be within an operating regime that would result in highly human legible CAPTCHAs. However, they also reported that there was weak correlation between the generating parameters and the desired properties, thus making automatic selection of suitably legible challenges difficult.

As discussed, while CAPTCHAs based on language models are easier to break, research has shown that humans find familiar text easier to read as opposed to unfamiliar text. A compromise that may be reached is to use random ‘language-like’ strings. For example, phonetic text or Markov dictionary strings can be generated pseudo-randomly to produce pronounceable strings that are not actual dictionary words. This compromise can be seen from the results of a usability study that examined string familiarity with degraded text images. This study showed that while the human reading accuracy of English words were higher than non-English words, the accuracy for pronounceable strings were better than that of completely random strings. However, it is obvious that in pronounceable strings, certain characters (e.g. vowels) will appear at a higher frequency than other characters.

Another usability issue is that before being able to identify individual characters in the string, humans must first be able to distinguish the text from any background clutter. In addition to its aesthetic properties, the use of colour or background textures can make the task of perceiving the text from the background easier. However, it has been shown that inappropriate use of colour and background textures can be problematic in terms of both usability and security. In general, if the background colour or texture can easily be separated from the text using an automated program, then it does not contribute to the security strength of the CAPTCHA and it may be better not to use it as it can actually harm usability. This is because it may make it hard to see the actual text or be distracting for a human user.

### 3D CAPTCHAs

A number of attempts at designing and developing 3D CAPTCHAs have recently emerged in literature and in practice. These approaches typically generate CAPTCHA challenges by rendering 3D models of text-objects or of other objects.

Kaplan (Kaplan, M. G. The 3D-CAPTCHA. http://spamfizzle.com/CAPTCHA.aspx) proposed a 3D CAPTCHA approach based on identifying labelled parts of 3D models. However, it has been pointed out pointed out that this approach is unlikely to scale due to the manual effort involved in modelling and labelling parts. The social networking site YUNiTi adopts a CAPTCHA that uses Lambertian renderings of 3D models. Users are presented with an image containing 3D objects and are required to select matching objects, in the sequence that they appear in the CAPTCHA, from a provided set of images. The 3D objects in the CAPTCHA are rendered using different parameters (e.g. different orientation and colour) from those in the selection set. Unfortunately, this approach is likely to be susceptible to attacks using basic computer vision techniques.

The same method of attack applies to the approach proposed by Imsamai and Phimoltares (Imsamai, M. and Phimoltares, S. (2010) 3D CAPTCHA: A Next Generation of the CAPTCHA. Proceedings of the International Conference on Information Science and Applications (ICISA 2010), Seoul, South Korea, 21-23 Apr., 2010, pp. 1-8. IEEE Computer Society.). They presented a number of 3D CAPTCHA scheme variants based on renderings of 3D text-objects. It can be seen that the characters in their approach do not undergo any form of distortion and, more importantly, the entire front face of characters are rendered using the same shade. tEABAG 3D (OCR Research Team tEABAG 3D Evolution. http://www.ocr-research.org.ua/teabag.html) is another approach that relies of 3D. However a segmentation attack is likely to be able to distinguish the text due to disruptions in the somewhat regular pattern surrounding it. Moreover, 3D object recognition is a well studied field, for example, Mian et al. (Mian, A. S., Bennamoun, M., and Owens, R. A. (2006) Three-dimensional model-based object recognition and segmentation in cluttered scenes. IEEE Trans. Pattern Anal. Mach. Intell., 28, 1584-1601) presented an approach to viewpoint independent object recognition and segmentation of 3D model-based objects in cluttered scenes. It is possible that attacks adopting such computer vision techniques will be able to successfully defeat these 3D CAPTCHAs.

Among 3D CAPTCHA ideas that have been proposed in the research community, Mitra et al. (Mitra, N.J., Chu, H.-K., Lee, T.-Y., Wolf, L., Yeshurun, H., and Cohen-Or, D. (2009) Emerging Images. ACM Trans. Graph., 28) proposed a technique of generating ‘emerging images’ by rendering extremely abstract representations of 3D models placed in 3D environments. This approach is based on ‘emergence’, the unique human ability to perceive objects in an image not by recognising the object parts, but as a whole. Ross et al. (Ross, S. A., Halderman, J. A., and Finkelstein, A. (2010) Sketcha: a CAPTCHA based on Line Drawings of 3D Models. In Rappa, M., Jones, P., Freire, J., and Chakrabarti, S. (eds.), WWW, pp. 821-830. ACM) presented a pilot usability study and security analysis of a prototype implementation of their CAPTCHA called ‘Sketcha’. Sketcha is based on oriented line drawings of 3D models and the user's task is to correctly orient images containing these 3D model line drawings.

All the prior art forms of CAPTCHA have unsuitable aspects which make them unsuitable for widespread adoption.

### SUMMARY OF THE INVENTION

In one aspect an improved form of CAPTCHA is provided.

In accordance with a first aspect of the present invention, there is provided a method of providing a Completely Automated Public Turing test to tell Computers and Humans Apart (CAPTCHA), the method comprising the steps of: providing a user with a stereoscopic image, said stereoscopic image having at least one candidate object having a stereoscopic depth distinguishable from other objects in the image; and requesting a response from the user identifying the candidate object.

In accordance with a first aspect of the present invention, there is provided a method of providing a Completely Automated Public Turing test to tell Computers and Humans Apart (CAPTCHA), the method comprising the steps of: forming a stereoscopic image including a first and second series of intermingled similar objects, with the first series of objects having a readily distinguishable stereoscopic depth from the second series of objects.

Preferably, the objects can include alphanumeric characters. The first and second series of objects can include portions overlapping members of each series. In one embodiment, the first series of objects are preferably all at a different stereoscopic depth from the second series. In some embodiments, the first series of objects are preferably at the same stereoscopic depth. In other embodiments, the first series of objects are preferably formed along a plane in the stereoscopic dimension of the stereoscopic image. In other embodiments, the objects have a predetermined rotation and yaw and pitch orientation in the stereoscopic dimension.

The objects are preferably scaled to all be of a similar size in the stereoscopic image. The objects can also include a predetermined degree of transparency. The stereoscopic image can be rendered for viewing utilising anaglyph glasses. The objects are preferably rendered in the stereoscopic image without texture.

In accordance with a further aspect of the present invention, there is provided a method of providing a CAPTCHA to a user, the method comprising the steps of: (a) forming a stereoscopic image including a first and second series of intermingled similar objects, with the first series of objects having a readily distinguishable stereoscopic depth from the second series of objects. (b) displaying the image to a user; (c) receiving an input from the user as to the first series of objects; (d) determining if the input is an accurate identifier of the first series of objects.

In accordance with a further aspect of the present invention, there is provided a system for providing users with a CAPTCHA for accessing a resource, the system including: first CAPTCHA calculation unit for forming a CAPTCHA image comprising stereoscopic image including a first and second series of intermingled similar objects, with the first series of objects having a readily distinguishable stereoscopic depth from the second series of objects; stereoscopic display system for displaying the stereoscopic image to a user; input means for receiving a users input determination of the objects which are members of the first series; authentication means for determining the correctness of the users input and thereby providing access to the resource.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1 illustrates a first rendered stereoscopic image with the color values all converted to a grey scale;

FIG. 2 illustrates a second rendered stereoscopic image rendered in a wireframe format with the color values all converted to a grey scale;

FIG. 3 to FIG. 5 illustrate the process of stereoscopic image interpretation by the eye;

FIG. 6 to FIG. 9 illustrate various left and right stereoscopic channel rendering;

FIG. 10 and FIG. 11 show example disparity map data; and

FIG. 12 illustrates schematically the operational environment of the preferred embodiment;

FIG. 13 illustrates a flow chart of the steps in utilizing a stereoscopic image in a CAPTCHA test.

### DETAILED DESCRIPTION OF THE INVENTION

In the preferred embodiments of the present invention there is provided a more effective form of CAPTCHA that utilises stereoscopic properties that is segmentation resistant whilst being human usable. The fundamental idea behind the preferred embodiment, herein after called STE-CAP, is to present CAPTCHA challenges to the user using stereoscopic images. This technique relies on the inherent human ability to perceive depth from stereoscopic images. If the stereoscopic CAPTCHA is designed well, the human decoding task is easy and natural for humans but made more difficult for current computer programs. By incorporating stereoscopic images in the CAPTCHA challenge, segmentation-resistant methods like adding clutter and ‘crowding characters together’ can be implemented to a higher degree whilst still maintaining usability. This is because to humans, the text in the resulting CAPTCHA will appear to stand out from the clutter in the perceived scene.

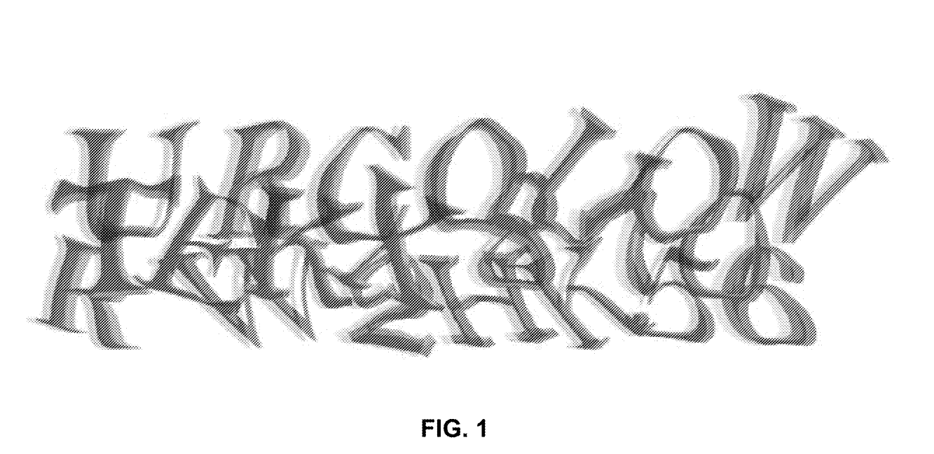

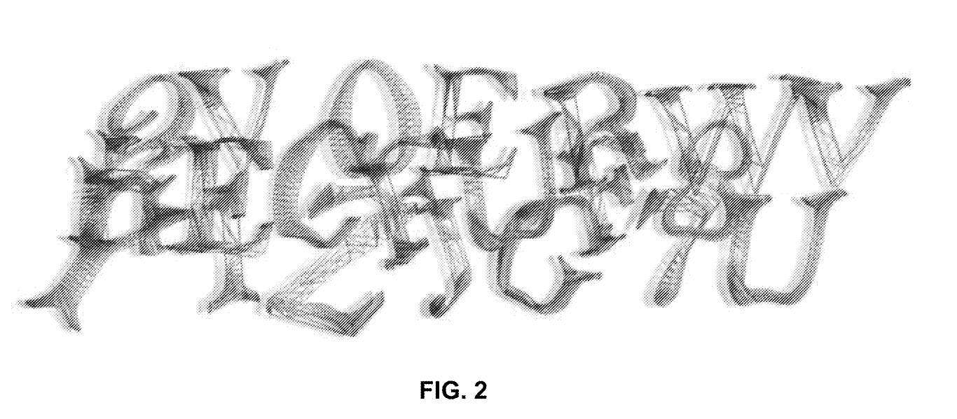

Two versions of STE-CAP are presented. A first relies on rendered characters appearing as solid objects, and the other that uses wireframe characters. Examples of these are shown in FIG. 1 and FIG. 2 respectively. These stereoscopic CAPTCHAs can be viewed using red-cyan anaglyph glasses. To solve the STE-CAP, a user must identify the foreground characters.

Many different forms of clutter can be utilised. For example, instead of adding random clutter, as used in a variety of other CAPTCHAs, in STE-CAP the clutter might consist of characters in the background. This appears as ‘text-on-text’ and the resulting CAPTCHA challenge is to distinguish the main characters from the background characters. By using text as the background clutter, the process of segmentation is made all the more difficult for computers.

The preferred embodiments can utilise differing techniques for the presentation of stereoscopic images. In some embodiments, specialised stereoscopic display hardware can be used to present stereoscopic images to the user. Other embodiments can rely on the simplified anaglyph approach to presenting STE-CAP challenges.

### CAPTCHA Formalised

von Ahn et al. (von Ahn, L., Blum, M., Hopper, N.J., and Langford, J. (2003) CAPTCHA: Using Hard AI Problems for Security. In Biham, E. (ed.), EUROCRYPT, Lecture Notes in Computer Science, 2656, pp. 294-311. Springer) defined CAPTCHA formally as “a cryptographic protocol whose underlying hardness assumption is based on an AI problem.” When the underlying Artificial Intelligence (AI) problem is useful, a CAPTCHA implies an important situation, namely either the CAPTCHA is not broken and there is a way to differentiate humans from computers, or the CAPTCHA is broken and a useful AI problem is solved [1].

### Definitions and Notation

The following definitions and notation are adapted and simplified from von Ahn et al. Intuitively, a CAPTCHA is a test V where most humans have success close to 1, while it is hard to write a computer program that has overwhelming probability of success over V. That means, any program that has high probability of success over V can be used to solve a hard AI problem. In the following, let C be a probability distribution. If PO is a probabilistic program, let Pᵣ(•) denote the deterministic program that results when P uses random coins r.

Definition 1.

A test V is said to be (α,β)-human executable if at least an α portion of the human population has success probability greater than β over V.

Definition 2.

An AI problem is a triple P=(S, D, f) where S is a set of problem instances, D is a probability distribution over S and f:S→{0,1}* answers the problem instances. Let δ∈(0,1). For α>0 fraction of the humans H, we require Pr_{x←D}[H(x)=f(x)]>δ.

Definition 3.

An AI problem P is said to be (ψ, T)—solved if there exists a program that runs in time for at most T on any input from S, such that Pr_{x←D,r}[Aᵣ(x)=f(x)]>ψ.

Definition 4.

An (α,β,η)-CAPTCHA is a test V that is (α,β)-human executable and if there exists B that has success probability greater than η over V to solve a (ψ, )—hard AI problem , then B is a (ψ, ) solution to .

Definition 5.

An (α,β,η)-CAPTCHA is secure if there exists no program B such that: Pr_{x←D,r}[Bᵣ(x)=f (x)]≧η for the underlying AI problem .

### Enhanced stereoscopic 3D CAPTCHA: STE-CAP-e

The preferred embodiment, STE-CAP-e, is a text-based CAPTCHA that is designed to be human usable, yet at the same time robust against a variety of automated attacks. The underlying concept behind STE-CAP-e is to present the CAPTCHA challenge to the user via stereoscopic images. When viewed in as stereoscopic images, legitimate human users should be able to distinguish the main text from the background clutter. This approach exploits the difference in ability between humans and computers in the task of stereoscopic perception.

### Design and Implementation

The security strength of a CAPTCHA is determined by the cumulative effects of its design choices. STE-CAP-e was designed to overcome flaws, by addressing the following issues in its design and implementation:

Instead of using random clutter, in STE-CAP-e the background clutter consists of characters themselves. This ‘text-on-text’ approach makes it extremely difficult for a computer to correctly segment the resulting CAPTCHA. On the other hand, stereoscopy is part of the human visual system and when STE-CAP-e is viewed in 3D, humans should be able to identify the foreground characters from the background characters. STE-CAP-e also uses random characters. As such, holistic approaches that rely on a database of dictionary words (or phonetic strings) to identify entire words will not work. In addition, STE-CAP-e is a variable length CAPTCHA. Variable length CAPTCHAs are harder to segment as the attacker has limited prior knowledge regarding the exact length of the solution. STE-CAP-e uses both local and global warping. This significantly deters pixel-count attacks. Random 3D transformations are also implemented for all characters in STE-CAP-e. Thus, increasing the difficulty of attacks.

All characters are rendered using the same color. Therefore, color cannot be used as a criteria to separate the background from the foreground. Furthermore, STE-CAP-e adopts the ‘crowding characters together’ approach for both the background and foreground characters, and also overlaps character rows, which makes the task of segmentation all the more difficult.

A current implementation of STE-CAP-e consists of 3 rows, with 7 characters per row. The character set is made up of capital letters and digits. Characters in the rows are made to overlap in the vertical direction and the characters in the columns are crowded together in the horizontal direction, at times overlapping or joining together. The foreground characters consist of 3 to 5 characters, in sequence, that can start from any location in the middle row. Initial implementations allowed foreground characters to take random locations, but this had usability implications as it confused users.

The other reason for restricting foreground characters to the middle row, is because it may be possible to identify characters in the top and bottom rows by trying to recognise the top part or bottom part of the characters in those rows. Placing the foreground characters in the middle row circumvents this. Although in doing so, attackers will have this information. Nevertheless, this does not make the task of segmentation or identifying individual characters any easier, due to the overlapping characters from both the top and bottom rows.

It should be noted that STE-CAP-e can easily be expanded to contain more rows and columns, and longer foreground character strings. However, this was thought to make the challenge unnecessarily confusing. In addition, a variety of factors can also be adjusted (e.g. amount of local and global warping, transformation range, etc.) Two versions of STE-CAP-e were implemented, one by rendering characters as solid objects and the other by rendering them in wireframe. Examples of these were previously shown in FIG. 1 and FIG. 2 respectively.

### Issues Relevant to STE-CAP-e

In light of the fact that STE-CAP-e uses a novel stereoscopic approach to present CAPTCHA challenges, there are several issues unique to STE-CAP-e that are not relevant to other CAPTCHAs. These are set out as follows.

### Stereoscopy

Stereoscopy relates to the perception of depth in the human visual system that arises from the interocular distance (i.e. the distance between the eyes). When presented with a stereo pair, two images created for the left and right eyes respectively, the human visual system perceives the sensation of depth through a process known as stereopsis. Stereopsis relies on binocular disparity (i.e. the difference in the images that are projected onto the left and right eye retinas, then onto the visual cortex), to obtain depth cues from stereoscopic images. Stereoscopic display technologies simulate binocular disparity by presenting different images to each of the viewer's eyes independently. If the stereoscopic images are generated correctly, the visual cortex will fuse the images to give rise to the sense of depth. There are a variety of different stereoscopic display technologies, a comprehensive overview can be found in McAllister (McAllister, D. (2002) 3D Displays. Wiley Encyclopedia on Imaging, Pacific Grove, Calif.).

The preferred embodiments are designed to work with all forms of stereoscopic imaging. Some forms require the utilisation of specialised stereoscopic display hardware which normally adds significant cost. To avoid this limitation, one form of embodiment utilises a low-cost anaglyph approach. In the anaglyph approach, the viewer is presented with a single image that is colour encoded to contain both left and right images. By using a pair of anaglyph glasses (e.g. with red/cyan filters), the glasses filter out colours of different frequencies for each eye, thus each eye sees a different image. Anaglyph glasses are cheap to produce and one can even make their own pair.

The preferred embodiment can be used as a drop-in replacement for current CAPTCHAs on web services.

There are a number of factors to consider when generating stereoscopic images. One of which is referred to as stereoscopic parallax, or simply parallax. Parallax is the distance (which can be positive or negative) between the projected positions of a point in the left and right eye views on the projection plane. A point in space that is projected onto the projection plane can be classified as having one of three relationships:

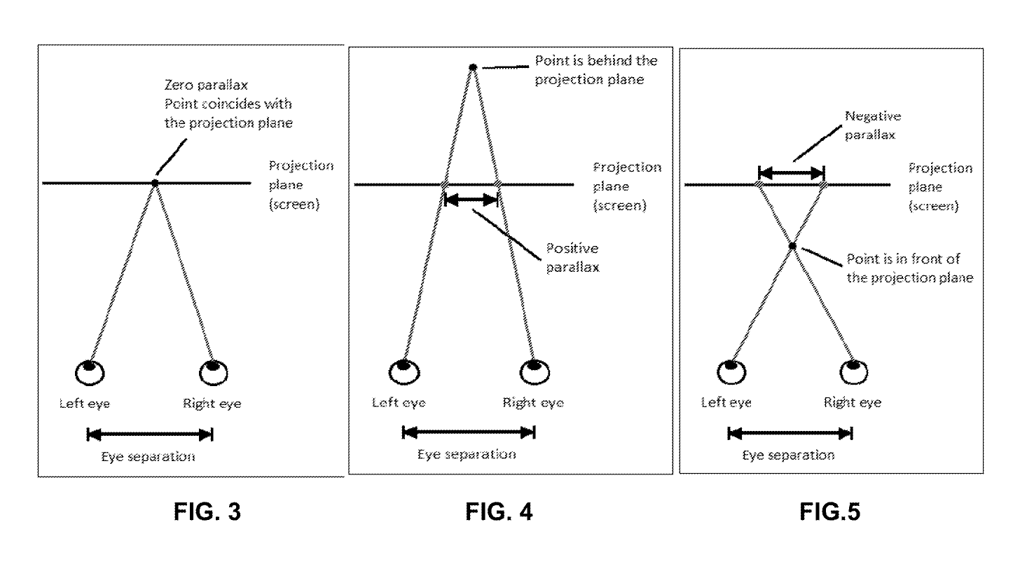

FIG. 3 illustrates the case of zero parallax. This occurs when the projected point coincides with the projection plane. This will result in the pixel position of the projected point being at exactly the same position in the anaglyph image.

FIG. 4 illustrates the case of positive parallax. Positive parallax occurs when the projected point is located behind the projection plane. In this case, the pixel position of the projected point is located on the right for the right eye, and on the left for the left eye. When presented for human stereoscopic perception, the point will appear at a depth ‘into’ the screen.

FIG. 5 illustrates the case of negative parallax. Negative parallax occurs when the projected point is located in front of the projection plane. When this happens, the pixel position of the projected point is located on the left in the right image and on the right in the left image. Presented for human stereoscopic perception, the viewer will perceive the point as coming ‘out’ of the screen.

Since STE-CAP-e challenges are generated for human stereoscopic perception, this allows greater flexibility in the random transformation of characters in 3D. In traditional CAPTCHAs characters can only be randomly translated in the horizontal and vertical dimensions, and rotated clockwise or counterclockwise. In STE-CAP-e characters can be randomly translated ‘into’ or ‘out of’ the screen. In addition to clockwise and counter-clockwise rotation, the characters in STE-CAP-e can also have random rotations in terms of their yaw and pitch.

In normal perspective projection, objects will get smaller with distance from the viewer. However, this can be avoided in STE-CAP-e, as otherwise separating foreground from background characters will be a simple matter of distinguishing characters based on their size. As such, the characters in STE-CAP-e are scaled in a way that makes them all appear to be of similar sizes when rendered in the 2D image, despite them being at different depths in 3D.

Another issue that should to be addressed was how to make it difficult for computer vision techniques to reconstruct the 3D scene. To achieve this, characters in STE-CAP-e are rendered in a random order with a degree of translucency. This effectively blends the colours of the foreground and background characters together and creates a ‘see-through’ effect (the degree of which can be adjusted), thus making it harder for attacks involving image processing and computer vision techniques.

### Limitations

The unique nature of STE-CAP-e also results in a number of limitations: STE-CAP-e is a visual CAPTCHA, and like all other visual CAPTCHAs, it is not accessible to those with visual impairments. In addition, STE-CAP-e cannot be used by individuals who are stereo-blind.

To view STE-CAP-e, a stereoscopic display approach has to be used. For the anaglyph approach, this requires a pair of anaglyph glasses. While these are inexpensive to produce, it gives rise to the limitation that individuals who are colour-blind, or have a colour defect which coincides with the anaglyph colour filters, will not be able to perceive the stereoscopic STE-CAP-e. This can be overcome using other stereoscopic display approaches (e.g. autostereoscopic displays or active shutter glasses). However, the distribution of such devices is limited. To comfortably view STE-CAP-e challenges in 3D, its display size cannot be too small.

New AI Problem Family: To commence, the following terminology is defined: An image is defined as an h×w matrix (where h stands for height and w stands for width), whose entries are pixels. A pixel is defined as a triplet (R,G,B), where 0≦R,G,B≦M, for a constant M. Let _{2d} be a distribution on 2D images (i.e. anaglyph), and _{3d} be a distribution on 3D images, _{2d} be a distribution on 2D transformations, and _{3d} be a distribution on 3D transformations, that includes rotation, scaling, translation and warping. The depth of a 3D image is denoted by d, where d=0 represents a foreground image. Let _{3d}: _{3d}→ _{3d} be a transformation function that accepts a 3D image and produces a distorted 3D image. Let _{2d}: _{2d}→ _{2d} be a transformation function that accepts a 2D image (anaglyph) to produce a distorted 2D image. Functions _{3d} and _{3d} apply local warping/distortion to each 3D image and global warping/distortion to the final 2D image. Let : _{3d}× → _{3d} be a function that transforms a 3D image (that is originally at depth d=0) to a 3D image of depth d∈ . Let : _{3d}× → _{3d} be a function that ‘extracts’ the 3D image at layer d∈ to produce a new 3D image. Let ∈: _{3d}× → _{2d} be an anaglyph extraction function, that extracts an anaglyph image (in the _{2d} set) from a 3D image (in the _{3d} set). Note that for practicality, it is assumed that any new 3D image created will have depth d=0 (i.e. in the foreground). Let : _{3d}× _{3d}→ _{3d} be a function that combine two 3D images into a single 3D image. Let Δ:| _{3d}|→ _{3d} be the cardinality of A. Let Δ:| _{3d}|→ _{3d} be a lookup function that maps an index in | _{3d}| and outputs a 3D image in _{3d}. Let be the length of the STE-CAP-e challenge. Let γ be the number of layers that will be used for the clutter in STE3DCAP-e.

### Problem Family (_{STE-CAP})

The creation of a STE3DCAPe can then proceed by the following steps:

1. Randomly select : {∈| _{3d}|^{l}}.

2. For each i∈ , compute :={i<→Δ(i)}.

3. For each i∈ , compute :={ _{3d}(i)}.

4. For β:=1 to γ do

(a) Randomly select :{c∈| _{3d}|^{l}}.

(b) For each c∈\check{}, compute \check{}:={c←Δ(i)}.

(c) For each c∈\check{}, compute \check{}:={ _{3d}(c)}.

(d) For each c∈\check{}, compute ^:={ (c,β)}.

(e) For each i∈ , c∈\check{}, compute :={i c}.

5. Compute :=∈( ).

6. Compute := _{2d}( ).

7. Output as the STE-CAP-e challenge.

The output of the steps is . Note that | |=l, is the length of the STE-CAP-e challenge. The total number of objects in is (γ+1)l, where γ is the number of layers used in the STE-CAP-e clutter. Assuming that Δ⁻¹: _{3d}→| _{3d}| and ∈⁻¹: _{2d}→ _{3d} exist, then the answer to the STE-CAP-e challenge is: ν=∀_{c∈∈}_{^{−1}}₍ ₎(Δ⁻¹({ (c,0)})).

_{STE-CAP-e} is to write a program that takes as input and outputs ν, assuming the program has precise knowledge of _{3d} and _{2d}.

### Hard Problem in _{STE-CAP}

It is believed that PSTE-CAP-e contains a hard problem. Given , for any program , Pr[ ᵣ( )=ν]<η. Based on this hard problem, it is possible to construct a secure (α,β,η)-CAPTCHA. The secure (α,β,η)-CAPTCHA can be constructed from _{STE-CAP-e} as defined above. This can be shown by two stages. Firstly, it is shown that (α,β,η)-CAPTCHA is (α,β)-human executable. Then, it is shown that (α,β,η)-CAPTCHA is hard for a computer to solve. Finally, an instantiation of the proof is given.

Given , humans can easily see ∀_{c∈∈}_{^{−1}}₍ ₎(Δ⁻¹({ (c,0)})), by ignoring all the clutter, ∀_{c∈∈}_{^{−1}}₍ _{),δ≠0}{ (c,δ)}. In other words, the problem of computing \∀_{c∈∈}_{^{−1}}₍ _{),δ≠0}{ (c,δ)} and Δ⁻¹ \∀_{c∈∈}_{^{−1}}₍ _{),δ≠0}{ (c,δ)} are easy for humans. Hence, the solution to ∀_{c∈∈}_{^{−1}}₍ ₎(Δ⁻¹({ (c,0)})) is easy for humans, as the result can easily be seen by humans (equipped with a pair of anaglyph glasses).

On the other hand, while computers will be given the same problem , the function Δ⁻¹ does not exist and thus, the computation of ∀_{c∈∈}_{^{−1}}₍ ₎(Δ⁻¹({ (c,0)})) is not feasible for computers to perform.

Hence, it is clear that machines will not be able to output the solution to the problem instance _{STE-CAP-e}. Therefore, Pr[ ᵣ( )=ν]<η will hold as claimed.

### Security Analysis

This section presents analysis on the security of STE-CAP-e. An adversary, A, will have access to the STE-CAP-e challenge, . A's main goal is to output ν=∀_{c∈∈}_{^{−1}}₍ ₎(Δ⁻¹({ (c,0)})). In this section several possible attack scenarios are examined that can be used to attack STE-CAP-e and the formalisation of these attacks.

Brute Force Attacks:

To attack a STE-CAP-e challenge, , can launch a straightforward attack by adopting the brute force strategy. In this attack, will provide a random solution to the challenges until one succeeds. This means that given , will try a random answer to solve the challenge. Since STE-CAP-e is a variable-length CAPTCHA, its length of the correct answer is Suppose that there are 36 possible characters which comprise of case insensitive letters and digits, then the chance of a successful brute force attack is

$$\frac{1}{{36}^{𝓁}} .$$

Having attempted n times, the overall chance will be

$${( \frac{1}{{36}^{𝓁}} )}^{n} ,$$

which is negligible. Furthermore, in practice CAPTCHAs can be usually combined with techniques such as token bucket algorithms to combat denial-of-service attacks.

Single Image Attacks:

In a single image attack, is provided with an anaglyph STE-CAP-e challenge, . Note that this image is a 2D image. will be interested to extract ν from . There are several strategies that can employ to conduct this attack, Including: Anaglyph filtering technique; Edge detection technique; 3D reconstruction technique. These techniques are discussed in detail as follows.

Edge Detection Technique

The aim of the edge detection technique is to find the edges of the objects in the given image, . Since is a 2D image, directly conducting an edge detection method on this image will include all the clutter embedded in the image. It was found that the resulting image does not yield any useful information that can be used to reveal ν.

### Anaglyph Filtering Technique

The aim of this attack is to separate the ‘left’ image from the ‘right’ image of , and then try to analyse them. This is possible because in an anaglyph image, the two images are colour encoded to produce a single image. Hence, separate left and right images can simply be obtained by filtering the anaglyph image using appropriate colour filters (usually red/cyan, red/blue, or red/green).

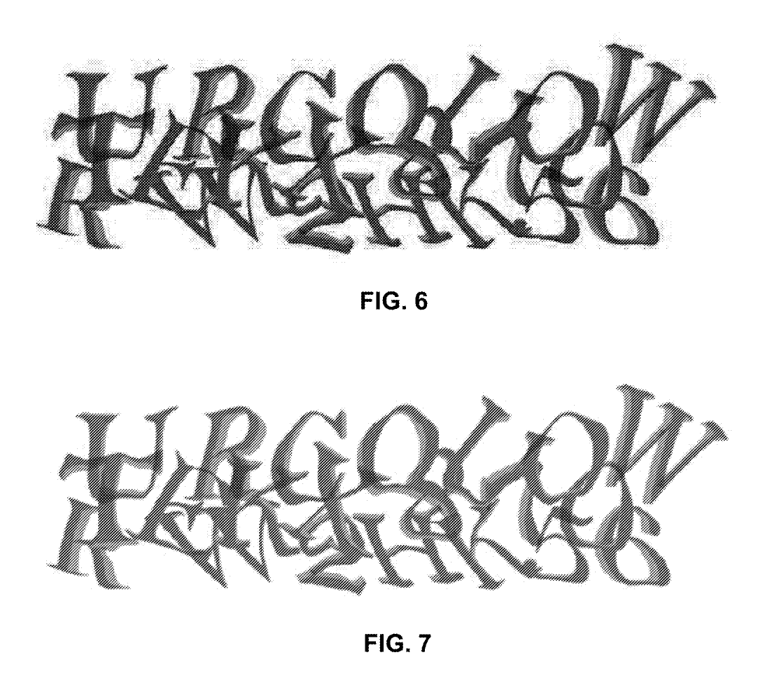

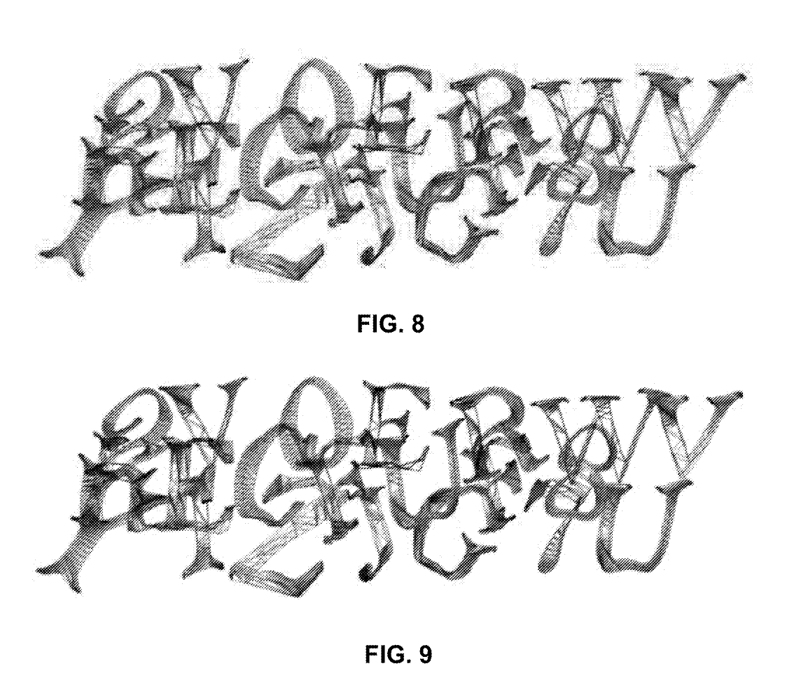

Examples of separate left and right images after filtering are shown in FIG. 5 and FIG. 6 for the filled character case and FIG. 7 and FIG. 8 for the wireframe character case. Formally, we define two functions ∈_{left}: _{2d}→ _{2d} and ∈_{right}: _{2d}→ _{2d} as extraction functions for left and right colours, respectively.

The attack is conducted as follows.

1. Compute _{left}:→∈_{left}( ).

2. Compute _{right}:→∈_{right}( ).

The attacker, , can try to run an edge detection filter on these separate images. This may not give rise to information that will make the segmentation task any easier. If the foreground characters were to completely block the background characters, this would appear as completely clear regions. This is not the case because STE-CAP-e challenges were rendered using a certain degree of translucency, therefore the foreground characters do not completely occlude the background characters.

With _{left} and _{right}, can also try to analyse these by obtaining the differences between them. This is because foreground characters will have a different parallax compared to background characters. Formally, let _{diff}= _{left}− _{right}, where − denotes any preprocessing and image difference operations. The difference images were found to not yield much useful information for the task of segmentation, because of the significantly overlapping characters.

In order to make a successful attack, should compute _{new}:= \∀_{c∈∈}_{^{−1}}₍ _{),δ≠0}{ (c,δ)} and then compute _{left}:=∈_{left}( _{new}) and _{right}:=∈_{right}( _{new}). Upon obtaining these values, can compute _{diff} _{left}− _{right} and possibly apply a thresholding or edge detection technique, either before or after _{diff}. Nevertheless, it is not feasible to compute _{new}, since the function ∈⁻¹1 does not exist and cannot be ascertained from _{diff}. Hence, this attack is unlikely to succeed.

### 3D Reconstruction Technique

The purpose of this attack is to estimate 3D information from the given anaglyph image. This will require the use of a stereo correspondence algorithm. Stereo correspondence, a process that tries to find the same features in the left and right images, is a heavily investigated topic in computer vision. The result of this is typically to produce a disparity map, an estimate of the disparity in the left and right images, which may subsequently be used to find depth discontinuities or to construct a depth map, if the geometric arrangement of the views is known.

One of the problems in stereo matching is how to handle effects like translucency.

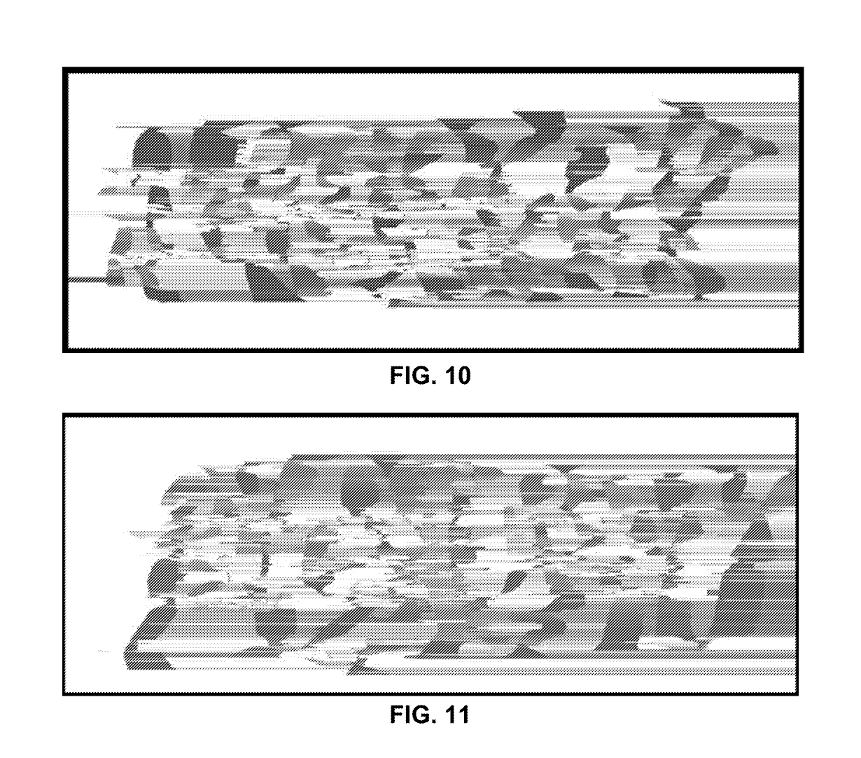

Therefore, the design of STE-CAP-e is such that all characters are preferably rendered with a degree of translucency. Furthermore, many stereo matching algorithms require texture throughout the images, as untextured regions in the stereo pair can give rise to ambiguity. STE-CAP-e is preferably rendered without the use of textures. FIG. 10 and FIG. 11 shows examples of disparity maps obtained using the algorithm in Birchfield and Tomasi (Birchfield, S. and Tomasi, C. (1999) Depth discontinuities by pixel-to-pixel stereo. International Journal of Computer Vision, 35, 269-293). It can be seen that the resulting disparity maps do not produce much useful 3D information required to break STE-CAP-e.

Formally, can try to infer 3D information from the stereo images, which can be obtained using the anaglyph filtering approach outlined in the previous section. Hence, aims to compute: _{3d}:=∈⁻¹( ). Nevertheless, since ∈⁻¹ does not exist, this attack cannot easily be conducted. If ∈⁻¹ exists, then will be challenged to compute: _{3d}\∀_{c∈∈}_{^{−1}}₍ _{),δ≠0}{ (c,δ)}. Note that { (c,δ)} for all δ≠0 cannot be done efficiently either.

### Machine Learning Attacks

The aim of this attack is to provide supervised training data to the adversary, , in order to equip with sufficient knowledge that can be used to attack the system. Intuitively, a training set of STE-CAP-e challenges will have to be provided with their respective solutions, ν's. Then, after the training is conducted, will be given a fresh STE-CAPe challenge, in which has to solve using the knowledge from its database. This attack is inspired by the supervised learning approach in machine learning and the notion of known plaintext attacks in cryptographic literature.

The outline of a practical situation adopting this attack is as follows. Consider a ‘smart’ attacker program being trained by a human. The human is presented with several STE-CAP-e challenges, and the human can answer these challenges correctly. This information supplied to the attacker program as supervised training data and will be conducted during the learning stage. Once the learning stage is over, the program will be presented with a fresh STE3DCAP-e challenge. This time, the attacker program will need to answer the challenge itself, given the knowledge that it has gathered during the learning stage. The second stage is known as the attacking stage. The attack is considered successful if the attacker program can answer the fresh STE-CAP-e challenge correctly. Formally, this attack is defined as a game among the challenger , an attacker and a human as follows.

Stage 1. Learning Stage

1. Define :=0.

2. Repeat this process q times: For all CAPTCHA challenges given by (i.e. ), the human will perform the following.

(a) Output the correct answer ν.

(b) Add this knowledge to , i.e. := ∪{ ,ν}.

3. Output

Stage 2. Attacking Stage

At this stage the attacker is equipped with =∀ᵢ( ᵢ,νᵢ), where | |=q.

1. outputs a fresh CAPTCHA challenge ∀ᵢνᵢ}, where {∀ᵢνᵢ}∈ .

2. needs to answer with the correct ν.

Note that the required ν in the challenge stage is ν {∀ᵢνᵢ}, where {∀ᵢνᵢ}∈ .

Note, a CAPTCHA is secure against machine learning attacks if no adversary can win with a probability that is non-negligibly greater than

$${( \frac{1}{n} )}^{𝓁} ,$$

where is the length of the CAPTCHA challenge, and n represents the number of characters used in the CAPTCHA challenge. STE-CAP-e is thought secure against machine learning attacks. During the learning stage, can form a data set :={ ᵢ,νᵢ}. During the attacking stage, will be provided with a STE-CAP-e challenge . Note that ∉{∀ᵢνᵢ}, where ∉ . Therefore, Pr( ∉|{∀ᵢνᵢ}, where :={ ᵢ,νᵢ})=Pr ( ). Hence, the knowledge of clearly does not help to solve the fresh STE-CAP-e challenge, .

### Active Attacks

In this section, we will describe active attacks against STE-CAP-e. This is the strongest type of attacks that can be launched against CAPTCHAs. There are two type of attacks: chosen CAPTCHA challenge attacks and chosen CAPTCHA response attacks. These attacks are elaborated as follows.

### Chosen CAPTCHA Challenge (CCC) Attacks

The idea of Chosen CAPTCHA Challenge (CCC) attacks is inspired by the notion of chosen plaintext attacks in the public key cryptography setting. Essentially, the attacker is provided with a CAPTCHA challenge generator, CG (in our case, it will be a STE-CAP-e challenge generator). As in machine learning attacks, there are two different stages; namely, the learning stage and the attacking stage. In the learning stage, can invoke at any time. accepts an input i∈| _{3d}|, and outputs a 3D image i∈ _{3d}. Once the learning stage is over, is provided with a fresh CAPTCHA challenge, . 's task is to output the correct ν, where ν=∀_{c∈∈}_{^{−1}}₍ ₎(Δ⁻¹({ (c,0)})).

This attack is to capture the following scenario. Consider a CAPTCHA implementation that is embedded in a website as a Java applet. An attacker can eventually download the applet code (which is an executable binary code), which can be used to produce the CAPTCHA offline. This means that, can eventually provide an input to the applet code, and the applet code will display the CAPTCHA challenge. In our case, the code will display a STE-CAPe challenge. However, it should be noted that also knows the corresponding ν, which is the input to the applet code. This stage is what we refer to as the learning stage. Then, will go online to attempt the real CAPTCHA challenge. This constitutes the attacking stage. During this stage, will be presented with a CAPTCHA challenge, which is different from what has seen during the learning stage. 's task is to solve the CAPTCHA challenge by producing the correct response, ν. Formally, this is defined as a game between a challenger and an adversary as follows. Let be an oracle that accepts ν and produces a CAPTCHA challenge .

Stage 1. Learning Stage

1. Define :=0.

2. Repeat this process q times:

(a) Select a random ν.

(b) Execute = (ν).

(c) Execute := ∪{ ,ν}.

3. Output

Stage 2. Attacking Stage

At this stage, the attacker is equipped with =∀ᵢ( ᵢ,νᵢ), where | |=q.

1. outputs a fresh CAPTCHA challenge {∀ᵢ ᵢ}, where {∀ᵢ ᵢ}∈

2. needs to answer with the correct ν.

Note that the required ν in the challenge stage is ν {∀ᵢ ᵢ}, where {∀ᵢ ᵢ}∈ . A CAPTCHA is secure against Chosen CATCHA Challenge attacks if no adversary can win with a probability that is non-negligibly greater than

$${( \frac{1}{n} )}^{𝓁} ,$$

where l is the length of the CAPTCHA challenge, and n represents the number of characters used in the CAPTCHA challenge. It is thought STE-CAP-e is secure against CCC attacks for similar reasons to those mentioned above. The main difference here is the contents of the set . In the CCC attack game, the input to can be chosen arbitrarily by . Nevertheless, since Pr( |{∀ᵢ ᵢ}, where :={ ᵢ,νᵢ})=Pr( ); the knowledge of will not help in the attacking stage. Additionally, if can solve the attacking stage correctly by producing ν, this means that can solve the following problem: given , can output the corresponding where ν=∀_{c∈∈}_{^{−1}}₍ ₎(Δ⁻¹({ (c,0)})). This contradicts with the hardness of the problem _{STE-CAP}.

### Chosen CAPTCHA Response (CCR) Attacks

The idea of Chosen CAPTCHA Response (CCR) attacks is inspired by the notion of chosen ciphertext attacks (CCA1) in the public key cryptography setting. This attack is stronger than the CCC attack. In this type of attack, the attacker is equipped with a CAPTCHA challenge generator, , as in the CCC attack. In addition, is provided with a human helper during the learning stage. Hence, can either provide ν to generate (i.e. by invoking the CAPTCHA challenge generator) or provide to the human helper in this stage to obtain ν. Once the learning stage is over, will be provided with a fresh CAPTCHA challenge, which is different from what has seen during the learning stage. 's task is to solve the CAPTCHA challenge by producing the correct response, ν.

This attack is to capture the following scenario. As in the CCC attack, the attacker can somehow obtain a copy of the implementation applet of the CAPTCHA from the webpage. In addition, the attacker is helped by a human to train its data set, as in the machine learning attack. Hence, the attacker can widen its data set prior to the attacking stage. Once the learning stage is over, the attacker is provided with a real and fresh CAPTCHA challenge. 's task is to solve the CAPTCHA challenge by producing the correct response, ν. It is easy to see that this attack is stronger than the CCC attack. In fact, this type of attack can be considered as a combination between the CCC attack and the machine learning attack.

Formally, this is defined as a game between a challenger and an adversary as follows. Let be an oracle that accepts ν and produces a CAPTCHA challenge . Let Ω_{R} be an oracle that accepts a CAPTCHA challenge and produces ν. Note that Ω_{R} is only available to during the learning stage.

Stage 1. Learning Stage

1. Define :=0.

2. The following two processes can be executed interchangeably.

(a) Repeat this process q_{c} times:
i. Select a random ν.
ii. Execute :=Ω_{C}(ν).
iii. Execute := ∪{ ,ν}.

(b) Repeat this process q_{R} times:
i. Select a random .
ii. Execute ν:=Ω_{R}( ).
iii. Execute := ∪{ ,ν}.

3. Output

Stage 2. Attacking Stage

At this stage, the attacker is equipped with =∀ᵢ( ᵢνᵢ) where | |=q.

1. outputs a fresh CAPTCHA challenge {∀ᵢ ᵢ}, where {∀ᵢ ᵢ}∈ .

2. needs to answer with the correct ν.

Note that the required ν in the challenge stage is ν {∀ᵢ ᵢ}, where {∀ᵢ ᵢ}∈ .

A CAPTCHA is thought secure against Chosen CATCHA Response attacks if no adversary can win with a probability that is non-negligibly greater than

$${( \frac{1}{n} )}^{𝓁} ,$$

where l is in the length of the CAPTCHA challenge, and n represents the number of characters used in the CAPTCHA challenge. STE-CAP-e is thought secure against CCR attacks. This can be shown by extending the previous analysis. Here, the set is also added with := ∪{ ,ν} for any during the learning stage. Hence, the size of is | |=q_{C}q_{C} as stated. Using the same argument, it is noted that Pr( |{∀ᵢ ᵢ}, where :={ ᵢ,νᵢ})=Pr( ), and hence, the knowledge of will not help in the attacking stage. That means, no matter how big the size of that is provided, this knowledge will not help during the attacking stage. Further, as in the previous discussion of the CCC game, if can solve the attacking stage correctly by producing ν, that means can solve the following problem: given , can output the corresponding ν where ν=∀_{c∈∈}_{^{−1}}₍ ₎(Δ⁻¹{ (c,0)})). This contradicts with the hardness of the problem STE-CAP.

### Usability

User studies with human participants are the best method of establishing the human-friendliness of a CAPTCHA. As such, a pilot study was conducted to determine the usability of STE-CAP-e. A total of 28 participants (10 female and 18 male) took part in the pilot study. Participants consisted of a mixture of university staff and students, all of whom had normal or corrected normal vision, and their ages ranged between 21 to 55 (average ˜33.5, standard deviation ˜8.96).

For the study, a total of 36 STE-CAP-e challenges were generated with an 800×300 resolution. Of these, 18 were generated using the solid object approach and the other 18 using the wireframe approach. Each approach contained an equal number of challenges with lengths of 3, 4 and 5, respectively (i.e. 6 challenges per category). The experiment was designed to be short to avoid participants loosing concentration. Total time required to complete the experiment varied between participants, but took no longer than 7 minutes. A program was written to present the STE-CAP-e challenges to participants in a randomised sequence, with the same conditions maintained for all participants. The program also timed and recorded all answers. Before the experiment, each of the participants was given instructions about the experimental task and what they were required to do. Their task was simply to view each challenge and enter the correct answer using the keyboard. To familiarise themselves with the experimental task, participants were allowed to do a short trial run of the experiment, which contained 3 STE-CAP-e challenges that were not part of the set used in the actual experiment. Participants were told prior to the experiment that the answer to each challenge ranged from 3 to 5 case insensitive letters and digits, and that their answers would be recorded and timed. They were also given a post-experiment questionnaire that contained questions about their subjective opinions in relation to the usability of STE-CAP-e.

From the results of the experiment, the overall accuracy, with accuracy being determined based on the number of correct answers, was 86.71%. The amount of time taken by participants to solve individual challenges varied rather widely, with an average response time of approximately 6.5 seconds per challenge. Results of the solid object and wireframe approaches were compared, and it was found that the wireframe approach gave rise to a higher accuracy at 88.29%, while the accuracy of the solid object approach was 85.12%. On average, participants also took longer to solve challenges generated using the solid object approach as opposed to the wireframe approach. Nevertheless, tests indicated that these differences between the means were not statistically significant.

A breakdown of the accuracy based on the number of characters contained in the challenges showed that in the case of the wireframe approach, the accuracy decreased as answer length increased. A one-way ANOVA indicated that this was statistically significant, with F(2, 81)=9.8, p<0.001. This trend was not mirrored in the solid object approach. Of the number of incorrect answers for the solid object approach, 17.33% were for answers of wrong length, 80% for answers with 1 wrong character and 2.67% were for answers with 2 wrong characters. For the wireframe approach, 8.62% of the incorrect answers were of the wrong length, 77.59% were due to 1 wrong character and 13.79% were because of 2 wrong characters. No incorrect answers contained more than 2 wrong characters. It can be seen that the majority of incorrect answers were due to answers containing 1 wrong character.

A number of participants commented that the distortion and transformations made a few characters confusing, as it was hard to differentiate between certain letters and digits. Upon closer examination of participants' recorded answers, it was found that the majority of incorrect answers were due to confusion between particular digits and letters; namely, ‘O’ and ‘0’, ‘I’ and ‘1’, ‘Q’ and ‘2’, as well as ‘A’ and ‘4’. This is possibly also due to unfamiliarity with the font that was used. In fact, it was found that 40.6% of the incorrect answers were due to mistakes where the participant entered one of the above mentioned digits instead of the correct letter, or vice versa. While this did not occur in this user study, it should be noted that letters and digits like ‘S’ and ‘5’, and ‘B’ and ‘8’ could also potentially be confusing.

When asked to rate the usability of STE-CAP-e as compared to existing

CAPTCHAs, on a scale of 1 (much harder to use) and 7 (much easier to use), with 4 being neutral, the average response was ˜5.04 (standard deviation ˜1.29). This was followed by a ‘yes’ or ‘no’ question as to whether the participant believed that STE-CAP-e could be deployed on the Internet in its current form. Of the 28 participants, 23 gave a positive response. However, not surprisingly the main concern raised by most participants was that not everybody had a pair of anaglyph glasses.

For good usability, and to avoid users getting annoyed, it is thought that the human success rate of a good CAPTCHA should approach 90%. The overall result from this pilot study just about satisfies this benchmark, and this suggests that both solid object and wireframe versions of STE-CAP-e are human usable. Furthermore, it is anticipated that the human success rate will significantly improve if digits are removed from STE-CAP-e challenges. This will avoid users getting confused between particular digits and letters. As this was observed to be a major source of incorrect answers in this study, the removal of digits will certainly improve the usability of STE-CAP-e.

Other usability issues that can be factored in to increase usability, is prevent confusing character combinations. For example, ‘V’ ‘V’, which could be mistaken to be a ‘W’, and vice versa.

### Example Implementation

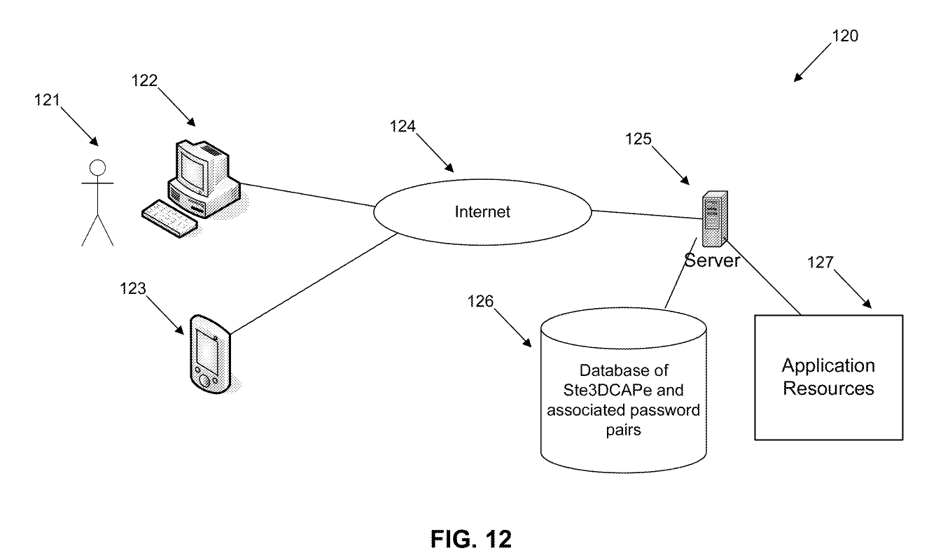

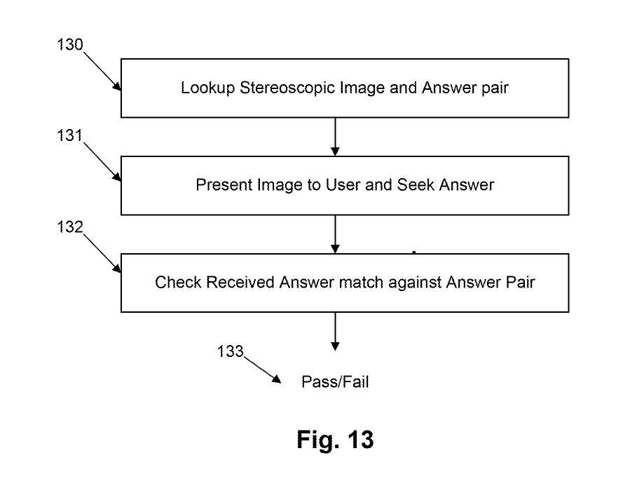

It would be understood by those skilled in the art that the preferred embodiment can be implemented in many different environments where a CAPTCHA test is required. For example, one common environment is an Internet environment where access to application resources is required. FIG. 12 illustrates one such environment. In this environment a user 121 accesses a server 125 which provides application resources 127. Access can be via a standard terminal interface 122 or, for example, mobile interface devices 123. The server 125 implements the stereoscopic CAPTCHA process which the user 121 must pass before access is granted to the application resources. The stereoscopic CAPTCHAs can be precomputed and stored in a database126 along with there associates answer pairs. FIG. 13 illustrates the steps implemented by the server upon receiving an access request. Initially, a random stereoscopic image and associated answer is accessed from the database 130. The image is presented to the user and the stereoscopic object of interest requested as an answer 131. Next the received answer is checked against a database 132 to determine its accuracy and a pass or fail result 133 is output.

### CONCLUSION

Current CAPTCHAs generally suffer from a security-usability trade off. STE-CAP-e is a novel stereoscopic CAPTCHA approach that was designed to address these limitations. The result is a CAPTCHA that is both human usable and resistant against a variety of automated attacks. The notion behind this CAPTCHA approach is based on the human visual system's ability to perceive depth from stereoscopic images, and thus attempts to exploit differences in ability between humans and current computer programs. The main limitation being that stereoscopic display devices have yet to become ubiquitous.

Stereopsis is only one of a number of methods in which the human visual system can infer information required for the perception of depth. There are several other depth cues that may be exploited, such as lighting, shadows, and motion parallax. Even though for most people binocular disparity is the dominant depth cue, the human visual system is able to perceive relative depth information from these other cues. The advantage of using these other depth cues is that they can be presented using 2D images without having to rely on a stereoscopic display method.

As such, our work paves the way for the design of other CAPTCHA approaches that are based on depth perception. In addition, this concept can also be extended beyond visual CAPTCHAs that rely on character recognition challenges. For instance, instead of recognising text-based characters, the challenge could be to recognise 3D objects at particular depths in a scene.

### INTERPRETATION

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, Fig., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Although the present invention has been described with particular reference to certain preferred embodiments thereof, variations and modifications of the present invention can be effected within the spirit and scope of the following claims.

We claim:

1. A method of operating a system for providing a Completely Automated Public Turing test to tell Computers and Humans Apart (CAPTCHA), the system comprising at least one processor and at least one non-transitory computer-readable medium communicatively coupleable to the at least one processor and which stores instructions executable by the at least one processor, the method comprising:
providing a user with a stereoscopic image, said stereoscopic image having at least one candidate object having a stereoscopic depth distinguishable from the rest of the image; and
requesting a response from the user identifying the candidate object.

2. A method as claimed in claim 1 wherein said stereoscopic image includes a first series of candidate objects and a second series of intermingled similar objects, with the first series of objects having a readily distinguishable stereoscopic depth from the second series of objects.

3. A method as claimed in claim 2 wherein the objects include alphanumeric characters.

4. A method as claimed in claim 2 wherein said first and second series of objects include portions overlapping members of each series.

5. A method as claimed in claim 2 wherein said first series of objects are all at a different stereoscopic depth from the second series.

6. A method as claimed in claim 5 wherein said first series of objects are at the same stereoscopic depth.

7. A method as claimed in claim 5 wherein said first series of objects are formed along a plane in the stereoscopic dimension of the stereoscopic image.

8. A method as claimed in claim 2 wherein the objects have a predetermined rotation and yaw and pitch orientation in the stereoscopic dimension.

9. A method as claimed in claim 2 wherein the objects are scaled to all be of a similar size in the stereoscopic image.

10. A method as claimed in claim 2 wherein the objects include a predetermined degree of transparency.

11. A method as claimed in claim 2 wherein said stereoscopic image is rendered for viewing utilising anaglyph glasses.

12. A method as claimed in claim 2 wherein said objects are rendered in said stereoscopic image without texture.

13. A method as claimed in claim 1 wherein said objects are preprocessed to introduce warping or noise to the object shape.

14. A method of providing a Completely Automated Public Turing test to tell Computers and Humans Apart (CAPTCHA) to a user, the method comprising:
forming a stereoscopic image including a first and second series of intermingled similar objects, with the first series of objects having a readily distinguishable stereoscopic depth from the second series of objects.
displaying the image to a user;
receiving an input from the user as to the first series of objects; and
determining if said input is an accurate identifier of the first series of objects.

15. A method of providing a Completely Automated Public Turing test to tell Computers and Humans Apart (CAPTCHA), the method comprising:
forming a stereoscopic image including a first and second series of intermingled similar objects, with the first series of objects having a readily distinguishable stereoscopic depth from the second series of objects.

16. A system for providing users with a Completely Automated Public Turing test to tell Computers and Humans Apart (CAPTCHA) for accessing a resource, the system including:
first CAPTCHA calculation unit for forming a CAPTCHA image comprising stereoscopic image including a first and second series of intermingled similar objects, with the first series of objects having a readily distinguishable stereoscopic depth from the second series of objects;
stereoscopic display system for displaying the stereoscopic image to a user;
input means for receiving a users input determination of the objects which are members of the first series;
authentication means for determining the correctness of the users input and thereby providing access to the resource.
